(19) United States
(12) Patent Application Publication
(10) Pub. No.: US 2013/0070113 A1
(43) Pub. Date: Mar. 21, 2013

(54) Master and Slave Machine Vision System

(71) Applicants: Brian Martinicky, Portland, OR (US); Scott Wu, Lincoln, MA (US)

(72) Inventors: Brian Martinicky, Portland, OR (US); Scott Wu, Lincoln, MA (US)

(73) Assignee: Cognex Corporation, Natick, MA (US)

(21) Appl. No.: 13/612,094

(22) Filed: Sep. 12, 2012

Related U.S. Application Data
(60) Provisional application No. 61/534,367, filed on Sep. 13, 2011.

(51) Int. Cl. H04N 5/232

(52) U.S. Cl. 348/211.3; 348/E05.042

(57) ABSTRACT

The technology provides, in some aspects, methods and systems for triggering a master machine vision processor and a slave machine vision processor in a multi-camera machine vision system. Thus, for example, in one aspect, the technology provides a method that includes the steps of establishing a communications link between a slave machine vision processor and a master machine vision processor; receiving on the slave machine vision processor a data message from the master machine vision processor; and triggering the slave machine vision processor to perform a machine vision function, the triggering occurring at a frequency based upon the data message, wherein at least one triggering of the slave machine vision processor occurs independent of the master machine vision processor.

### RELATED APPLICATION

This application claims the benefit of priority of U.S. Patent Application Ser. No. 61/534,367 filed Sep. 13, 2011, entitled “Master and Slave Machine Vision,” the entirety of which is incorporated herein by reference.

### TECHNICAL FIELD

The technology pertains to machine vision systems and, more particularly, to methods and apparatus for multi-camera machine vision systems. The technology has applicability in numerous fields, including manufacturing and quality control processes.

### BACKGROUND

Machine vision refers to the automated analysis of images to determine characteristics of objects represented in the images. It is often employed in automated manufacturing and/or distribution lines, where images of objects are captured and analyzed (e.g., to check for defects). Examples of such machine vision systems are provided in prior works of the assignee, Cognex Corporation, such as U.S. Pat. Nos. 6,175,652, entitled, “Machine vision system for analyzing features based on multiple object images,” and 6,483,935, entitled “System and method for counting parts in multiple fields of view using machine vision.”

Single camera machine vision systems are relatively inexpensive and are suitable for a number of applications, such as inspecting automobile parts or other relatively large objects. However, certain applications require more complicated machine vision systems that utilize multiple cameras. For example, in semiconductor manufacturing, wafer elements are extremely small, and single camera vision systems typically cannot obtain the required resolution while still having the entire wafer in its field of view. Multi-camera machine vision systems address this problem by having individual cameras image a portion of the wafer within a small field of view and at a high resolution, and then combining the images together to create a representation of the entire wafer. While multi-camera systems are often preferable to single camera systems, they are often much more expensive as well.

### SUMMARY

In one aspect of the technology, a computerized method is provided for triggering a master machine vision processor and a slave machine vision processor in a multi-camera machine vision system. More specifically, the method includes the steps of establishing a communications link between a slave machine vision processor and a master machine vision processor; receiving on the slave machine vision processor a data message from the master machine vision processor; and triggering the slave machine vision processor to perform a machine vision function, the triggering occurring at a frequency based upon the data message, wherein at least one triggering of the slave machine vision processor occurs independent of the master machine vision processor.

Related aspects of the technology provide establishing a communications link between one or more additional slave machine vision processors and the master machine vision processor. Further related aspects of the technology provide at least one triggering of the slave machine vision processor occurring independent of at lease one of the additional slave machine vision processors.

Further related aspects of the technology provide encrypting the data message sent from the master machine vision processor to the first slave machine vision processor.

Still further related aspects of the technology provide associating an identifier of the master machine vision processor with the data message. Still yet further related aspects of the technology provide authenticating the data message, based upon the identifier, as originating from the master machine vision processor.

Further related aspects of the technology provide triggering the slave machine vision processor to capture an image of an object with an image acquisition device associated with the slave machine vision processor. Related aspects of the technology provide performing, with the slave machine vision processor, a machine vision function on the image, wherein the machine vision function comprises a function that recognizes patterns in the image, the patterns including any of letters, numbers, symbols, corners, or other discernible features of the object.

In other aspects of the technology, a method is provided for master and slave machine vision triggering for use in a multi-camera machine vision system. More specifically, the method includes the steps of establishing a communications link between a master machine vision processor and at least a first slave machine vision processor and a second slave machine vision processor; sending a data message from the master vision processor to at least the first slave machine vision processor; and triggering the first slave machine vision processor to perform a machine vision function, the triggering occurring at a frequency based upon the data message, wherein at least one triggering of the first slave machine vision processor occurs independent of the second slave machine vision processor.

Related aspects of the technology provide at least one triggering of the first slave machine vision processor occurring independent of the master machine vision processor. Further related aspects of the technology provide defining a trigger limit for the first slave machine vision processor in the data message. Still further related aspects of the technology provide periodically sending additional such data messages to the first slave machine vision processor, wherein the period is based upon the trigger limit.

Related aspects of the technology provide encrypting, with the master machine vision processor, the data message sent to the first slave machine vision processor. Further related aspects of the technology provide decrypting, with the slave machine vision processor, the data message sent from the master machine vision processor.

In still other aspects of the technology, a master and slave machine vision system is provided that includes a master machine vision processor in data communications with at least a first slave machine vision processor and a second slave machine vision processor via a network link. The master machine vision processor sends a first data message to the first slave machine vision processor and a second data message to the second slave machine vision processor. The first and second slave machine vision processors each trigger to perform a machine vision function, wherein the triggers occur at a frequency based upon their respective first and second data messages. The first slave machine vision processor triggers, at least once, independent of the second slave machine vision processor.

Related aspects of the technology provide for systems as described above in which the second slave machine vision processor at least once triggers independent of the first slave machine vision processor.

Related aspects of the technology provide for systems as described above in which the first and second data messages each include an identifier of the master vision processor. Further related aspects of the technology provide for systems as described above in which the first and second slave machine vision processors authenticate the first and second data messages, respectively, as originating from the master machine vision processor.

Further related aspects of the technology provide for systems as described above in which the master machine vision processor encrypts the data messages sent to the first and second slave machine vision processors. Still further elated aspects of the technology provide for systems as described above in which the first slave machine processor decrypts the first data message and the second slave machine vision processor decrypts the second data message.

### BRIEF DESCRIPTION OF THE DRAWINGS

A more complete understanding of the technology can be attained by reference to the drawings, in which:

FIG. 1 depicts a master and slave machine vision system and environment according to one implementation of the technology;

FIG. 2 depicts a configuration and operation of a master machine vision processor in a master and slave machine vision system; and

FIG. 3 depicts a configuration and operation of a slave machine vision processor in a master and slave machine vision system.

### DETAILED DESCRIPTION

Architecture

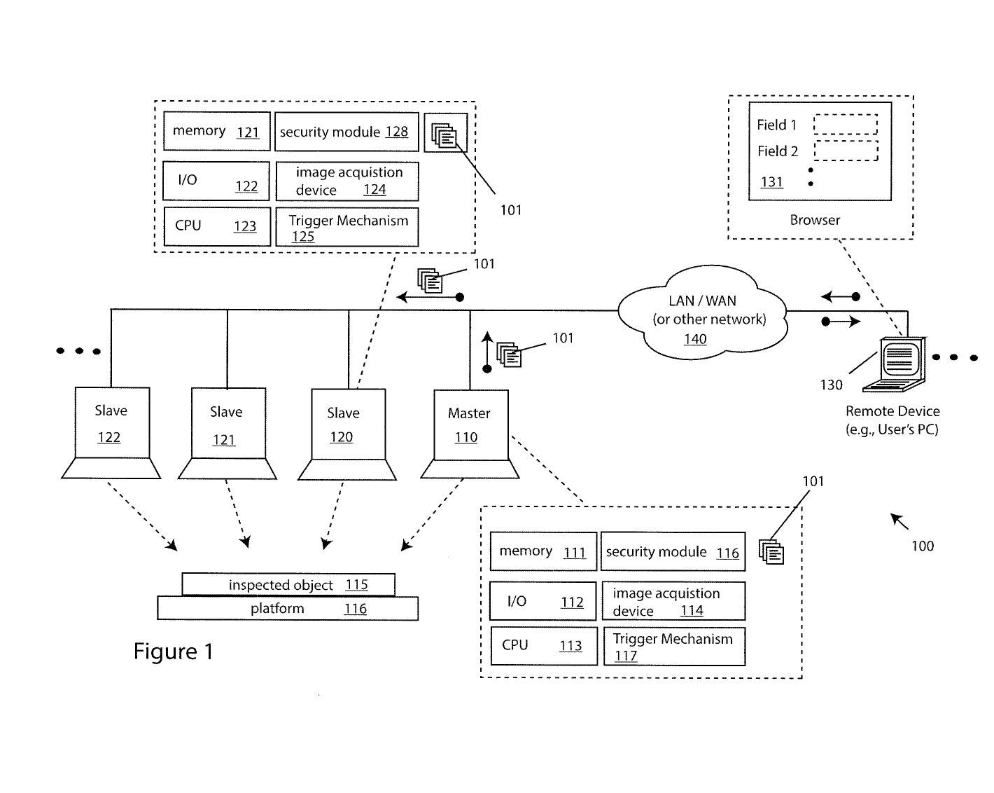

FIG. 1 depicts a master and slave machine vision system and environment 100 for triggering a master machine vision processor (“master”) 110 and one or more slave machine vision processors (“slaves”) 120-122 in order to perform a variety of machine vision functions (e.g., acquire an image of an object, inspect the image, etc.) according to one implementation of the technology. More specifically, the master 110 assigns a trigger lease to each slave 120-122 that ensures each slave 120-122 triggers at an allowable rate or frequency relative to the master 110. This is helpful, for example, when bundling a set of machine vision processors at a discounted price point because it effectively prevents a user from splitting up the bundle and having the slaves operate in separate locations, e.g., different assembly lines.

In the illustrated embodiment, the system 100 includes a master 110 connected to three slaves 120-122 via an IP-based local-area network (LAN) 140, although in other embodiments, it can be another type of network, such as the Internet, wide-area network (WAN), or otherwise, that can be public, private, non-IP based, etc. The illustrated master 110 and slaves 120-122 are configured to trigger an imaging and inspection of an object 115 from different respective viewpoints. While three slaves 120-122 are shown here, there can be a greater or lesser number of such devices in other embodiments.

The illustrated master 110 includes a memory 111, I/O 112, CPU 113, image acquisition device 114, trigger mechanism 117, and security module 118. Although each of these components 111-118 are shown and described in a single unitary structure, in other embodiments the components can be distributed among several devices and, for example, connected over a network. The master 110 is further configured to send data messages 101 to each slave device 120-122 over network 140, as discussed further below.

Illustrated image acquisition device 114 is a machine vision camera or other device capable of acquiring images of object 115 in the visible or other relevant spectrum. The image acquisition device 114 typically includes a lens and other image acquisition components (e.g., a charge coupled device (CCD) or other capture medium) of the type known in the art of machine vision systems.

In the illustrated embodiment, the object 115 is a semiconductor wafer, automobile part, pharmaceutical, or other object (or set of objects) suitable for machine vision imaging. As shown, the object 115 is disposed on a platform 116, such as a chuck or a motion stage, although in other embodiments, the object 115 can be disposed directly on a conveyer belt or otherwise.

The illustrated trigger mechanism 117 triggers the master 110 to acquire and inspect an image of object 115. For example, the trigger mechanism 117 can comprise a photocell or other switch that trips when the object 115 is within the camera's 114 field of view and ready for imaging. Alternatively, the mechanism 117 can be a software or hardware application that triggers the master 110 upon receiving a network message or other signal from an associated device, e.g., a programmable logic circuit (PLC).

The security module 118 encrypts, decrypts, authenticates, and/or otherwise secures communications between the master 110 and slaves 120-122. In the illustrated embodiment, the security module 117 implements a Blowfish encryption algorithm and an MD5 authentication algorithm, although other embodiment can use different algorithms (e.g., AES, DES, 3DES, etc.). For example, the security module 118 encrypts the data messages 101 (discussed below) prior to sending them to the individual slaves 120-122. Those skilled in the art will appreciate that in other embodiments, the functionality of the security module 118 can be found in another component of the master 110, e.g., I/O 112 or CPU 113, or in an associated device.

In the illustrated embodiment, the slaves 120-122 have physical configurations consistent with the master 110, including a memory 121, I/O 122, CPU 123, image acquisition device 124, and trigger mechanism 125, and are also configured to the image and inspect object 115 on platform 116. While the physical configuration of a master 110 and a slave 120-122 can be identical, each device is “branded” during manufacture causing it to operate as a either a master or a slave. In the illustrated embodiment, each device includes a security bit, e.g., in a read-only portion of memory 111,121, that indicates whether it is a master or a slave, although other embodiments designate master and slave devices differently.

As discussed briefly above and further below, each slave 120-122 is assigned a trigger lease by the master 110 that limits the rate and/or frequency that it is allowed to trigger. This prevents, for example, a user from deploying a slave 120-122 as a master in another system, or as a standalone system. The slaves 120-122 are further configured with security module 128 that encrypts decrypts, authenticates, and/or otherwise secures communications between the slaves 120-122 and master 110. For example, the module 128 can decrypt and authenticate incoming data messages 101, e.g., to ensure that the trigger lease originated from the master 110.

Illustrated remote device 130 comprises a personal computer (PC) connected to the network 140, although other embodiments can include different types of devices (e.g., laptops, servers, etc.), and/or a greater or lesser number of such devices. The remote device 130 is typically operated by a user, such as an engineer or systems administrator, to, for example, pair the master 110 with the slaves 120 (and vice versa), define trigger timings for the master 110, define trigger leases for the slaves 120-122, define encryption and authentication protocols, enable specified machine vision functions on the master 110 and slaves 120-122, and so forth. In the illustrated embodiment, a user can perform such operations with the input application 131. For example, the input application 131 can be a web browser, text editor, custom or generic Windows OS application, or other application designed to take input from a user.

Data Messages

The digital data messages 101 comprise network packets (e.g., IP packets) that are transmitted from the master 110 to the slaves 120-122 over network 140. In the illustrated embodiment, the data messages are encrypted on the master 110 and decrypted on each slave 120-122. Each slave device 120-122 can also authenticate each data message 101 to ensure that it originated from the master 110, e.g., to prevent a user from spoofing the system by sending illegitimate data messages to the slaves 120-122, thereby allowing them to trigger at a faster frequency than actually permitted. For example, the data messages 101 can include a model number or other identifier which the slaves 120-122 can use to compare with the model number or identifier of their paired master 110. Although encryption and authentication are used in the illustrated embodiment, other embodiments can use only one or neither, depending on situational security requirements.

As mentioned above, the data messages 101 include a trigger lease that specifies an allowable rate or frequency that a slave 120-122 can trigger. For example, the lease can specify that a slave is only allowed to trigger twelve times before it either receives a new lease or ceases to respond to incoming triggers. The trigger lease effectively allows each slave 120-122 to trigger independently from the master 110 and/or other slaves 120-122 because while the lease specifies a rate or limit that it can trigger, it does not specify when it should trigger. Independent triggers are particularly advantageous in multi-camera systems because each camera is typically imaging a different portion of an object and will need to trigger at slightly different points in time, e.g., depending on the size of the object, speed of the conveyance system, etc. This is an improvement over traditional master and slaves systems which do not allow slaves to trigger independently, e.g., because the master sends a single message to all slaves to trigger at the same time.

The illustrated data messages 101 can also include machine vision function information as well. For example, rather than burning-in machine vision functions (e.g., pattern matching functions, etc.) during manufacture, a user can define functionality by instructing the master 110 to enable or disable various functions at run-time.

In the illustrated embodiment, a trigger lease is defined either by (1) a user, e.g., operating PC 130, or by (2) a master 110 based upon its own trigger timing, e.g., as set by a user operating PC 130, but in other embodiments the lease can be defined otherwise. For example, a user can instruct the master 110 to send a new lease to the slaves 120-122 after every ten triggers. The master 110 can then create and send a data message 101 that includes a lease allotment that accounts for latency (or other synchronization issues), such as a lease of twelve triggers. Thus, the slaves 120-122 can trigger faster than the master 110 as necessary to keep the devices 110, 120-122 in synch, but not fast enough that it could operate outside the confines of the master-slave relationship, e.g., on another assembly line.

Operation

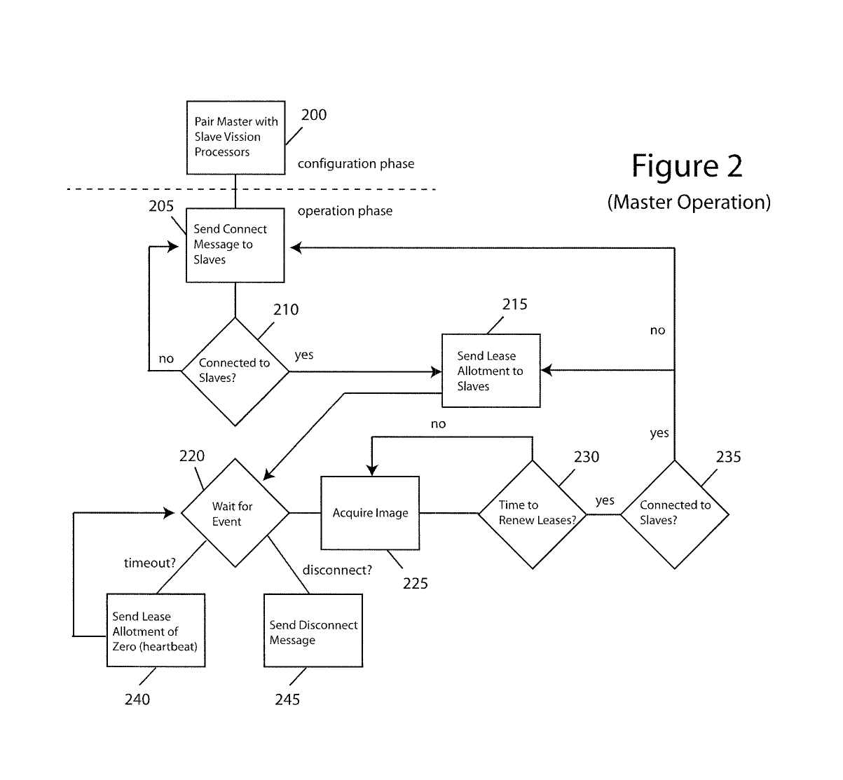

FIG. 2 is a flow diagram depicting an exemplary configuration and operation of the master 110 for triggering machine vision functions thereon and sending data messages 101 to the slaves 120-122 over the network 140 according to one implementation of the technology.

In step 200, the master is configured by (1) defining the slaves 120-122 that it will be paired with, and (2) defining a master trigger behavior. For example, a user operating PC 130 can use a graphical user interface (GUI) 131 to connect to the master 130, and enter the model number or other identifier of each slave 120-122 to be paired. In the illustrated embodiment, the master trigger behavior is a configurable number of successful triggers the master processes before sending a new lease to each slave 120-122 (e.g., 10 triggers); although in other embodiments it can simply be a trigger timing, which the master 110 can use to create the trigger allotments. For example, a user can instruct the master 110 to inspect one object 115 per second, and the master 110 can subsequently calculate the requisite lease allotments necessary to maintain synchronization between the devices 110, 120-122. As discussed above, a user can also enable/disable master machine vision functions during this phase, thereby removing the need to do so during manufacture.

In step 205, the master 110 initiates an operation phase by sending a connect message to each of the slaves 120-122 in the form of network packets (e.g., IP packets) in order to pair the devices 110, 120-122. If the pairing is successful, the master 110 sends a data message 101 including a lease allotment, e.g., twelve triggers, to the slaves 120-122, as shown in step 215. However, if the pairing is unsuccessful for one or more slaves 120-122, the master 110 returns to step 205 and sends another connect message to any disconnected slaves 120-122. In the illustrated embodiment, one disconnected slave 120-122 does not shutdown the entire system, i.e., the master 110 and other connected slaves 120-122 can continue to function, as discussed further below, although certain applications can require that all devices 110, 120-122 be operational in order to obtain a passing inspection of an object.

In step 220, the master 110 waits for, and processes, all incoming events. Events can include triggers (step 225), timeouts (step 240), and disconnect requests (step 245), to name a few. In step 225, the master is triggered by the mechanism 125, e.g., by a photocell, network message from a PLC, etc., to acquire an image of the object 115, and perform selected machine vision functions thereon (e.g., pattern matching). After completing the trigger event, the master 110 checks the master trigger behavior to determine whether to send a new lease to the slaves 120-122, as shown it step 230. For example, if the master trigger behavior is set at ten triggers, the master 110 sends a new lease only after ten triggers have been processed. If the master 110 has processed the amount of triggers defined by the master trigger behavior, it will check to make sure that it is still connected to the slaves 120-122, as shown in step 235. If still connected, the master 110 will refresh the leases on the slaves 120-122, as shown in step 215, and return to the waiting for event step 220. Alternatively, if the master 110 became disconnected from one or more slaves, the master 110 returns to step 205 and sends another connect message to those slaves.

In step 240, the master device 110 receives a “timeout” event. In the illustrated embodiment, the master 110 times out if it does not send a message to the slaves 120-122 within a prescribed amount of time, e.g., within the last 5 seconds. Upon receiving a timeout event, the master 110 sends a “heartbeat” message to the slaves 120-122, e.g., a lease allotment of zero additional leases or other innocuous message. As discussed further below, the slaves 120-122 disconnect if they do not receive a message from the master 110 within the timeout period, e.g., the last 5 seconds. This ensures, for example, that the slaves 120-122 will not function if the master 110 becomes inoperable or removed from the system 100. After sending the heartbeat message, the master 110 returns to step 220 (waiting for event), as shown.

In step 245, the master 110 sends a disconnect message to one or more selected slaves 120-122, which removes the pairing between the master 110 and selected slaves, and causes those slaves to wait for a further connection message before resuming operation, as discussed further below. In the illustrated embodiment, a disconnect message is typically initiated by a user, e.g., operating PC 130, that is reconfiguring the system 100. A disconnect message can also be sent in response to other events as well, however; e.g., because objects are no longer moving along the assembly line, or a slave is malfunctioning, etc.

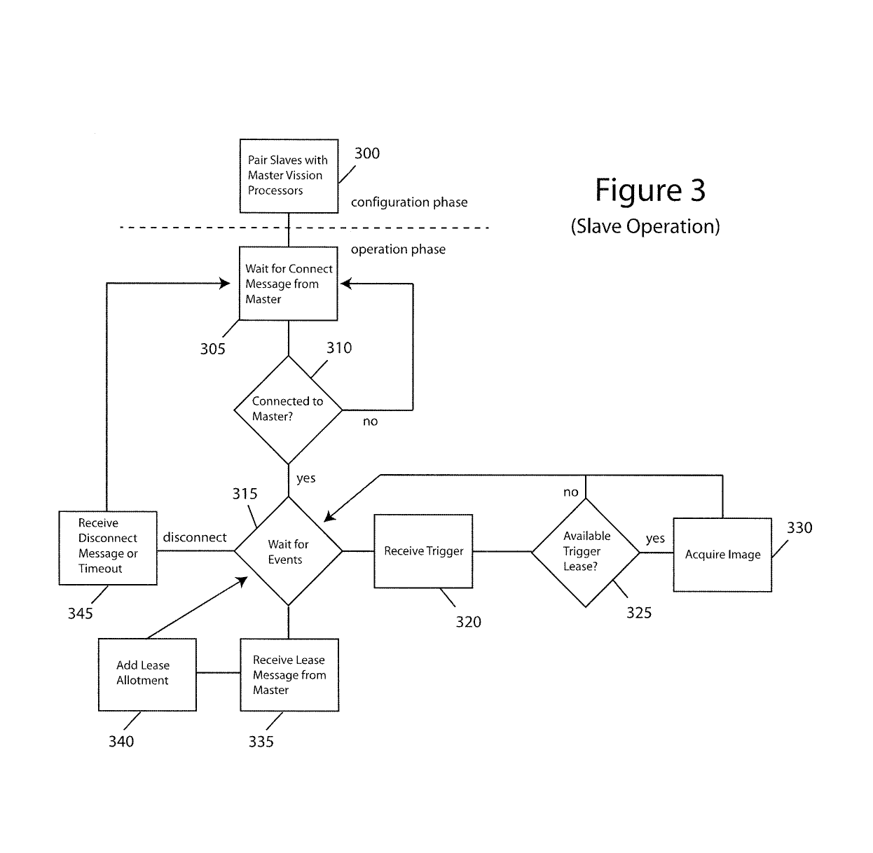

FIG. 3 is a flow diagram depicting an exemplary configuration and operation of the slave 120 for triggering machine vision functions thereon and receiving data messages 101 from the master 110 over the network 140 according to one implementation of the technology. The other slaves 121, 122 are configured and operate in a similar manner.

In step 300, the slave 120 is configured by selecting a master to which it will be paired. For example, a user operating remote device 130 can manipulate the GUI 131 to select the master 110 based upon its model number or other identifier. After a pairing has been selected or identified, the slave 120 can only connect to that specified master 110. As discussed above, configuration can also include enabling/disabling machine vision functions, thereby removing the need to do so during manufacture.

In step 305, the slave 120 waits for a connect message from the master 110. Upon receiving the connect message, it will attempt to complete the pairing with the master 110. If the attempt fails, e.g., because a different master sent the connect message, it returns to waiting for another connect message, as shown in steps 305-310. Alternatively, if the connection is completed, it begins waiting for incoming events, as shown in step 315.

In the illustrated embodiment, incoming events can include triggers (step 325), leases (step 335), disconnect requests (step 340), and timeouts (step 340), to name a few. In step 325, the slave 120 receives a trigger to image and inspect the object 115. Upon receiving a trigger event, the slave 120 checks its lease allotment for remaining triggers. For example, if the slave 120 has not yet received a lease from the master 110, or if it has already exhausted all of its allotted triggers, then the trigger mechanism 117 rejects the trigger event, and the slave 120 returns to waiting for additional events, as shown in steps 325 and 315.

Alternatively, if the slave 120 has already received a lease from the master 110, and if it has not already exhausted all of its allotted triggers, the slave 120 images and inspects the object 115, as shown in step 330. As discussed above, the slave 120 can process triggers independent of the master 110 and remaining slaves 121, 122. Upon successful imaging and inspection, the slave 110 subsequently modifies its lease allotment, e.g., by reducing the available triggers by one, and returns to waiting for additional events, as shown in step 315.

In step 335, the slave 120 receives a data message 101 from the master 110 including a trigger a lease. Upon receiving the lease, the slave 120 increases its trigger allotment accordingly, e.g., by adding the allotted triggers in the new lease to the current allotment, up to a capped amount, as shown in step 340. In the illustrated embodiment, the lease cap is equivalent to the initial lease allotment, thereby ensuring a slave cannot accumulate more triggers than initially assigned. Thus, for example, if the slave 120 received an initial lease allotment of twelve triggers, the slave cannot accumulate more than twelve triggers, regardless of how slow it is triggering or how often the master 110 refreshes the lease. In other embodiments, the initial lease can specify an additional element defining the lease cap, or it can be defined otherwise (e.g., in a separate data message).

In step 345, the slave 120 either receives a disconnect message from the master 110 or times out (e.g., because it has not received a message from the master 110 within a prescribed amount of time, as discussed above). Both events remove the pairing between the slave 120 and the master 110, and cause the slave 120 to return to waiting for a connect message (step 305). In the illustrated embodiment, one disconnected slave 120-122 does not shutdown the entire system, i.e., the master 110 and other slaves 121, 122 can continue to function, although certain applications can require that all devices 110, 120-122 be operational in order to obtain a passing inspection of an object.

Hardware and Software Considerations

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for longterm data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the technology can be embodied in other specific forms without departing from the spirit or essential characteristics thereof. The foregoing embodiments are therefore to be considered in all respects illustrative rather than limiting of the technology described herein. Scope of the technology is thus indicated by the appended claims, rather than by the foregoing description, and all changes that come within the meaning and range of equivalency of the claims are therefore intended to be embraced therein.

It will be appreciated that the illustrated embodiment and those otherwise discussed herein are merely examples of the technology and that other embodiments, incorporating changes thereto, fall within the scope of the technology.

In view of the foregoing, what we claim is:

1. A method of master and slave machine vision triggering for use in a multi-camera machine vision system, comprising:
A) establishing a communications link between a slave machine vision processor and a master machine vision processor;
B) receiving on the slave machine vision processor a data message from the master machine vision processor; and
C) triggering the slave machine vision processor to perform a machine vision function, the triggering occurring at a frequency based upon the data message, wherein at least one triggering of the slave machine vision processor occurs independent of the master machine vision processor.

2. The method of claim 1, further comprising establishing a communications link between one or more additional slave machine vision processors and the master machine vision processor.

3. The method of claim 2, further comprising at least one triggering of the slave machine vision processor occurring independent of at lease one of the additional slave machine vision processors.

4. The method of claim 1, further comprising encrypting the data message sent from the master machine vision processor to the first slave machine vision processor.

5. The method of claim 1, further comprising associating an identifier of the master machine vision processor with the data message.

6. The method of claim 5, further comprising authenticating the data message, based upon the identifier, as originating from the master machine vision processor.

7. The computerized method of claim 1, further comprising triggering the slave machine vision processor to capture an image of an object with an image acquisition device associated with the slave machine vision processor.

8. The computerized method of claim 7, further comprising performing, with the slave machine vision processor, a machine vision function on the image, wherein the machine vision function comprises a function that recognizes patterns in the image, the patterns including any of letters, numbers, symbols, corners, or other discernible features of the object.

9. A method of master and slave machine vision triggering for use in a multi-camera machine vision system, comprising:
A) establishing a communications link between a master machine vision processor and at least a first slave machine vision processor and a second slave machine vision processor;
B) sending a data message from the master vision processor to at least the first slave machine vision processor; and
C) triggering the first slave machine vision processor to perform a machine vision function, the triggering occurring at a frequency based upon the data message, wherein at least one triggering of the first slave machine vision processor occurs independent of the second slave machine vision processor.

10. The method of claim 9, further comprising at least one triggering of the first slave machine vision processor occurring independent of the master machine vision processor.

11. The method of claim 9, further comprising defining a trigger limit for the first slave machine vision processor in the data message.

12. The method of claim 11, further comprising periodically sending additional such data messages to the first slave machine vision processor, wherein the period is based upon the trigger limit.

13. The method of claim 11, further comprising encrypting, with the master machine vision processor, the data message sent to the first slave machine vision processor.

14. The method of claim 13, further comprising decrypting, with the slave machine vision processor, the data message sent from the master machine vision processor.

15. A master and slave machine vision system, comprising:
A) a master machine vision processor in data communications with at least a first slave machine vision processor and a second slave machine vision processor via a network link;
B) the master machine vision processor sending a first data message to the first slave machine vision processor;
C) the master machine vision processor sending a second data message to the second slave machine vision processor;
D) the first and second slave machine vision processors each triggering to perform a machine vision function, the triggering occurring at a frequency based upon their respective first and second data messages; and
E) the first slave machine vision processor at least once triggering independent of the second slave machine vision processor.

16. The system of claim 15, further comprising the second slave machine vision processor at least once triggering independent of the first slave machine vision processor.

17. The system of claim 15, wherein the first and second data messages each include an identifier of the master vision processor.

18. The system of claim 17, wherein the first and second slave machine vision processors authenticate the first and second data messages, respectively, as originating from the master machine vision processor.

19. The system of claim 15, wherein the master machine vision processor encrypts the data messages sent to the first and second slave machine vision processors.

20. The system of claim 19, wherein the first slave machine processor decrypts the first data message and the second slave machine vision processor decrypts the second data message.
